(19) United States
(12) Patent Application Publication
(10) Pub. No.: US 2015/0314149 A1
(43) Pub. Date: Nov. 5, 2015

(54) Integrated drag system

(71) Applicant: Robert Michael BRIGGS, JR., Antioch, IL (US)

(72) Inventor: Robert Michael BRIGGS, JR., Antioch, IL (US)

(21) Appl. No.: 14/120,170

(22) Filed: May 2, 2014

(51) Int. Cl. A62B 35/00

(52) U.S. Cl. CPC A62B 35/0037; A62B 35/0068

(57) ABSTRACT

An integrated drag system for substantially attaching to a predetermined article associate with a person, wherein the article may be a pair of suspenders or a tactical vest. The apparatus may have a grasping area, and an anchor system for securing to the predetermined article. The apparatus may also have an extendable portion having at least one extendable section having the first stowed position and a second extended position. The at least one extendable section may have a first end coupled to the anchor system and a second end operatively coupled to the grasping area.

### TECHNICAL FIELD

The invention relates generally to devices for moving a person, and more particularly to an integrated drag system for moving a casualty.

### BACKGROUND

Moving a casualty is one of, if not the most difficult thing military and law enforcement will encounter in the line of duty. An injured officer or soldier will usually completely change the mission. Injured personnel take away from the fighting force, in order to establish a rescue team, resulting in fewer guns in the fight. The best case scenario is either a self-rescue, in which the officer or soldier is ambulatory, or a single man rescue in which one individual is able to recover the injured person. Few systems allow for such a rescue and none do it quickly or efficiently.

Current systems do not consider the possible injuries the patient may have, anatomy that may be missing such as arms or legs, are in addition to, instead of integrated into, current equipment, and do not attempt to keep the patient in a neutral position. Current systems are unjustifiably high in cost. Additionally, current systems are open to user interpretation in regard to their use and application, or are field expedient solutions, rather than streamlined effective systems. No standard system exists currently that possesses the characteristics of utility, ease of use, reasonable cost, and passive application.

Therefore, there is a need for an improved method and system for quickly and safely moving an individually, especially a casualty.

### SUMMARY

One implementation encompasses a system useable for substantially attaching to a predetermined article associate with a person. This embodiment of the system may comprise: a grasping area, and an anchor system for securing to the predetermined article. The apparatus may also have an extendable portion having at least one extendable section having the first stowed position and a second extended position. The at least one extendable section may have a first end coupled to the anchor system and a second end operatively coupled to the grasping area.

In another embodiment the grasping area, the extendable portion and the anchor system may be integrated with a suspender system. The anchor system may be operatively coupled to a duty belt. The anchor system may have at least a pair of anchors that are releasably secured to space apart locations on the duty belt. The extendable portion may have a pair of extendable sections, each extendable section respectively having a first end operatively coupled to one of a respective anchor. Each extendable section may also have a second end that is operatively coupled to the grasping area. In one embodiment the grasping area and the pair of extendable sections may consist of a single strap like structure.

In another embodiment the article may be a tactical vest having a plurality of molles on a rear of the vest. The extendable portion extends through at least some of the plurality of molles. Respective anchors are operatively coupled to predetermined molles of the plurality of molles. The extended portion may be stowed in a predetermined molles of the plurality of molles also on the rear of the vest.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts one embodiment of the present system for an integrated drag system;

FIG. 2 depicts an embodiment of a portion of the FIG. 1 embodiment;

FIG. 3 depicts an embodiment of another portion of the FIG. 1 embodiment;

FIG. 4 depicts one embodiment of a portion of the FIG. 1 embodiment;

FIG. 5 depicts another embodiment of a portion of the FIG. 1 embodiment;

FIG. 6 depicts a cross section of the embodiment depicted in FIG. 5;

FIG. 7 depicts one embodiment of a portion of the FIG. 1 embodiment;

FIG. 8 depicts one embodiment of another portion of the FIG. 1 embodiment;

FIG. 9 depicts an embodiment showing the integrated drag system in a stowed position;

FIG. 10 depicts an embodiment showing the integrated drag system in an extended position;

FIGS. 11, 12, 13 depict various ways of using the integrated drag system; and

FIG. 14 depicts an alternative embodiment of the integrated drag system.

FIG. 15 depicts another alternative embodiment of the integrated drag system.

### DETAILED DESCRIPTION

In general terms the apparatus is useable for substantially attaching to a predetermined article associate with a person. In envisioned embodiments the article may be a pair suspenders or a tactical vest. The present apparatus may also be used with other articles associated with a person. In most general terms the apparatus may have a grasping area, and an anchor system for securing to the predetermined article. The apparatus may also have an extendable portion having at least one extendable section having the first stowed position and a second extended position. The at least one extendable section may have a first end coupled to the anchor system and a second end operatively coupled to the grasping area.

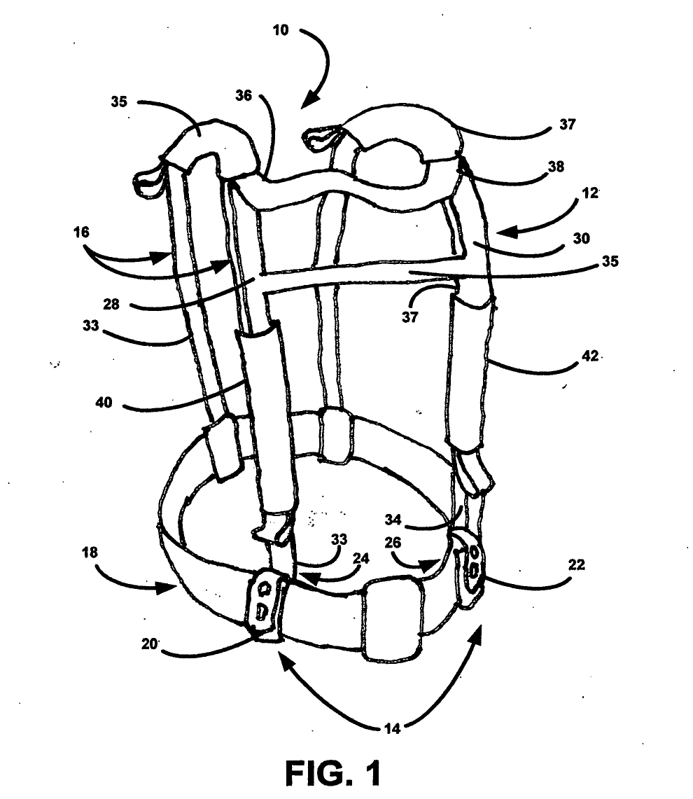

In one embodiment the grasping area, the extendable portion and the anchor system may be operatively coupled to an article, such as a belt, worn by a person. The article may also be, for example, a pair of suspenders that are attached to the belt of the person. The suspenders may have at least a pair of rear straps 33, 35 coupled together by a bridge strap 37 (see FIG. 1). The article may also be a tactical vest.

In another embodiment depicted in FIG. 1 the grasping area 10, the extendable portion 12 and the anchor system 14 may be integrated with a suspender system 16. The anchor system 14 may be operatively coupled to a duty belt 18.

The anchor system 14 may have at least a pair of anchors 20 and 22 that are releasably secured to spaced apart locations 24 and 26 on the duty belt 18. The extendable portion 12 may have a pair of extendable sections 28, 30. Each extendable section 28, 30 respectively may have a first end 32, 34 operatively coupled to one of a respective predetermined location 33, 35. Alternatively, each extendable section 28, 30 respectively may have a first end 32, 34 operatively coupled to one of a respective anchor 20, 22. Each extendable section 28, 30 may also have a second end 36, 38 that is operatively coupled to the grasping area 10. In one embodiment the grasping area 10 and the pair of extendable sections 28, 30 may consist of a single strap like structure.

In one embodiment each of the at least one extendable section 28, 30 may be temporally stored in a respective containing means 40, 42 structured for restoring the at least one extendable section 28, 30 after it has been extended. The containing means 40, 42 may be one of permanently attached to a respective extendable section 28, 30 or temporarily attached to the respective extendable section 28, 30. Also in other embodiments the containing means 40, 42 may comprise a plurality of containing sections.

In the stowed orientation each of the extendable sections 28, 30 may have at least a portion which is folded in a Z-fold fold configuration within the containing means 40, 42. It is to be understood that other configurations of folding may also be used.

In a further embodiment the apparatus may have further containing means 35, 37 for storing predetermined portions of the extendable sections 28, 30 to thereby effect an adjustable position of the grasping portion 10 relative to a size of the person wearing the apparatus. For example, the further containing means 35, 37 may be located approximately adjacent the shoulder areas of the person. The extendable sections 28, 30 may then be folded such they run at least twice through the respective further containing means 35, 37 on the shoulder area, and thereby provide for adjustment of the grasping area 10 relative to the shoulder area of the person.

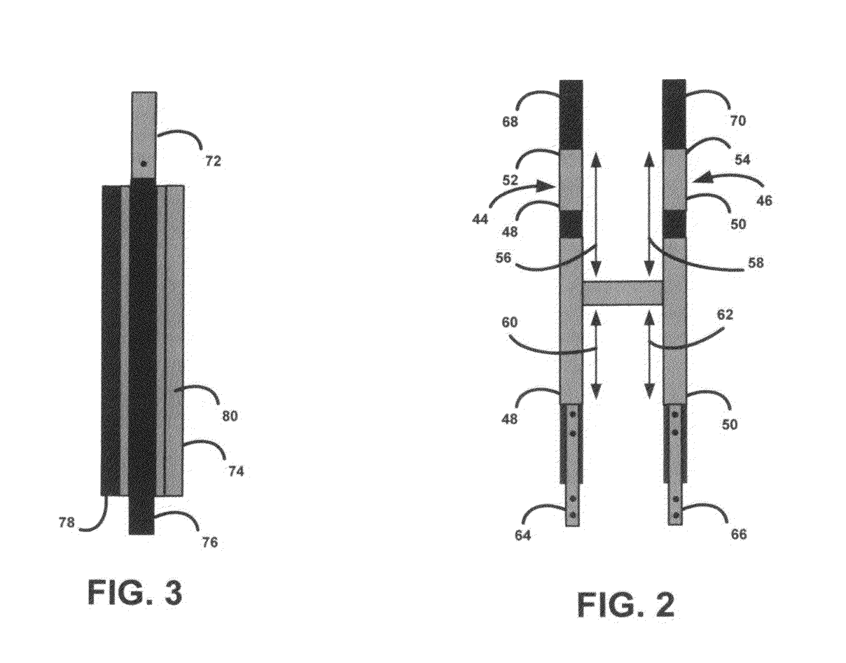

As depicted in FIG. 2 the article may consist of a pair of over the shoulder straps 44, 46, each of the shoulder straps 44, 46 having first ends 48, 50 and second ends 52, 54. Each of the shoulder steps 44, 46 may have a front strap portion 56, 58 and a rear strap portion 60, 62 and the anchor system may have four anchors 64, 66, 68, 70. Each of the first ends 48, 50 of the straps may be operatively coupled to a respective anchor 64, 66 of the four anchors 64, 66, 68, 70 that is operatively coupled to at least one belt of the person, the first ends 48, 50 being spaced apart from one another. Each of the second ends 52, 54 of the straps may be operatively coupled to a respective anchor 68, 70 of the four anchors 64, 66, 68, 70 that is operatively coupled to the at least one belt, the second ends 52, 54 being spaced apart from one another. Furthermore, the first ends 32, 34 of the extendable sections 28, 30 may be operatively coupled to predetermined locations on the rear strap portions 60, 62 of the shoulder straps 44, 46, respectively.

As depicted in FIG. 3 a rear strap 72 is showing laying on an open containing means 74. On top of the rear strap 72 is laid a folded portion of an extendable section 76. The containing means 74 in this embodiment has Velcro in areas 78 and 80 such that the containing means 74 may be closed over the rear strap 72 and folded portion of the extendable section 76 thereby keeping the extendable section 76 in the folded position until the extendable portion 76 is pulled out by applying force to be grasping area.

FIG. 4 is a cross-sectional view showing a rear strap 82 and anchor 84 operatively coupled to a location 86 on the rear strap 82. Also depicted is an extendable section 88 which is folded in an area 90 which has a containing means (not shown), and an area 92 which has a further containing means (not shown). A second end 94 of the extendable section 88 is operatively coupled to the grasping area 96.

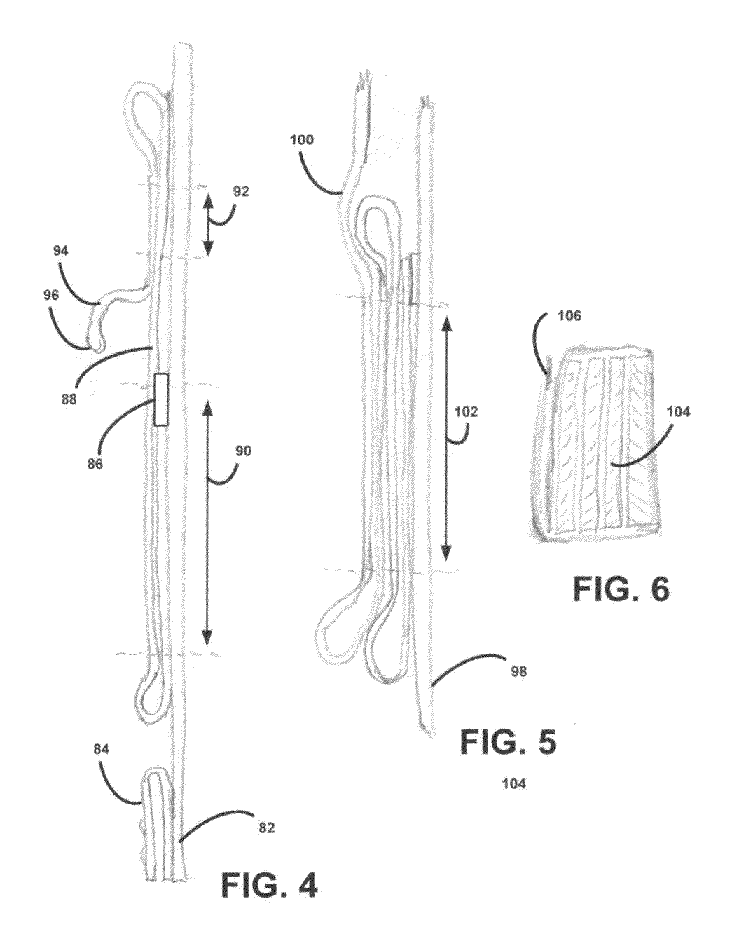

FIG. 5 is a cross-sectional view showing a rear strap 98 on which is folded an extendable section 100 which is temporarily held in area 102 by a containing means (not shown). As depicted the extendable section 100 may be folded a plurality of times in the containing means area 102.

FIG. 6 is a cross-sectional view depicting the extendable section 104 that is folded multiple times and temporarily secured by a containing means 106.

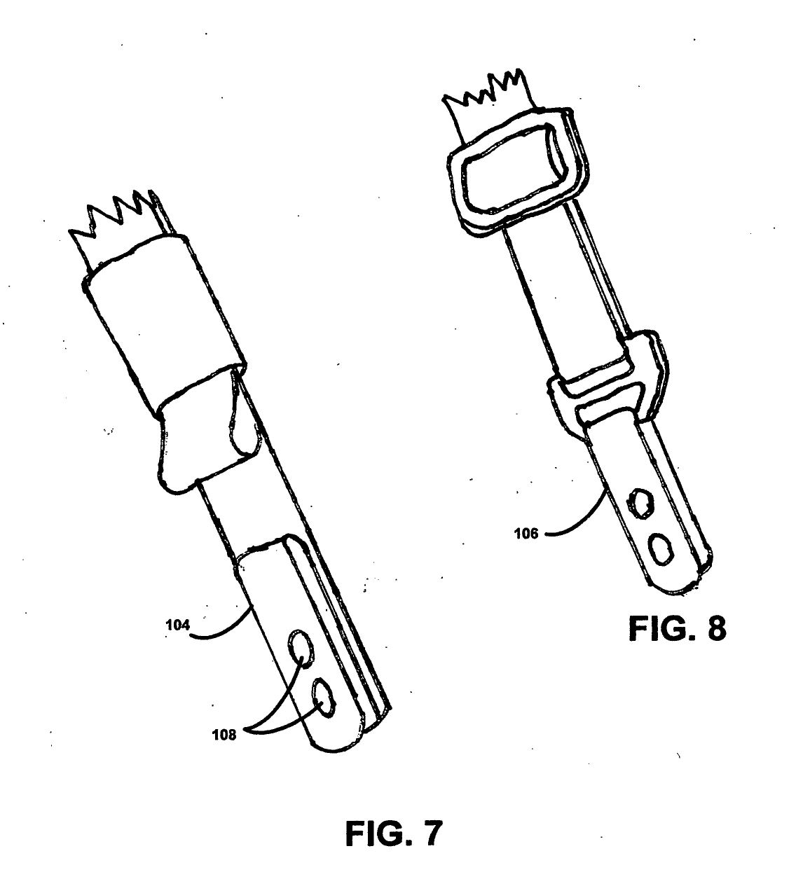

As depicted in FIGS. 7 and 8 each anchor may be a belt keeper 104, 106 that is operatively coupled to at least one belt worn by a person. The belt keeper 104, 106 may be orientated such that it is caused to remain in a closed position while a person is being dragged. Furthermore in other embodiments the respective anchor may be operatively coupled to one of an inner belt, a duty belt, and both the inner belt and duty belt. The anchor may be secured about the respective belt via snaps 108, Velcro or other means.

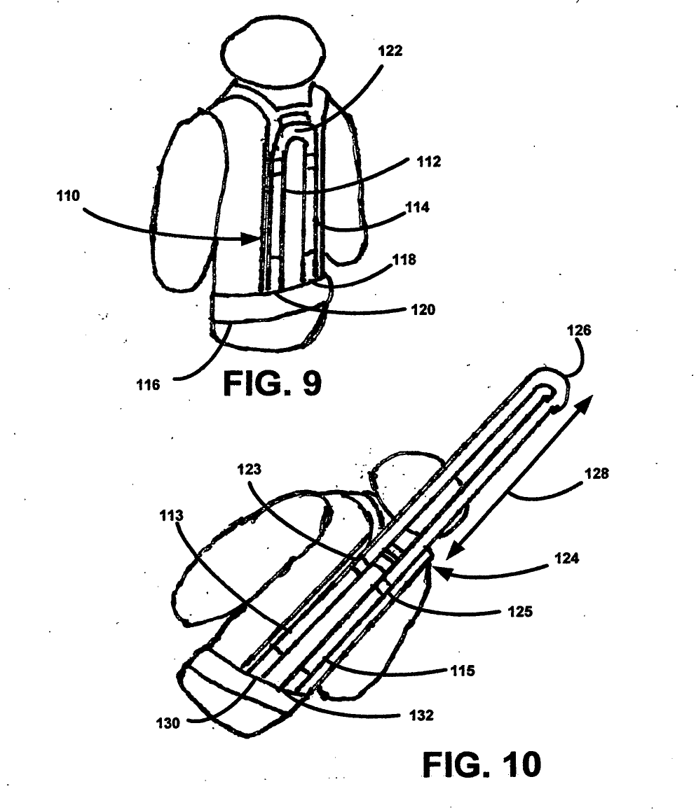

FIG. 9 depicts an extendable portion 110 in a stowed position on rear straps 112, 114 of a pair of suspenders. The rear straps 112, 114 may be operatively coupled to a duty belt 116 via anchors 118, 120. A grasping area 122 is substantially located near the shoulder area of a person.

FIG. 10 depicts an extendable portion 124 in an extended position in which the grasping area 126 is at a predetermined distance 128 from the shoulder area of the person. In the extended position of the extendable portion 124 at least a portion of a pulling force at the grasping area 126 is operatively transmitted via the extension portion 124 to respective anchors 130, 132 thereof. In the FIG. 10 embodiment first ends 123, 125 of the extendable portion 124 are attached respectively to the rear straps 113, 115. A force applied at the grasping area 126 is operatively transmitted via the extension portion 124 and the rear straps 113, 115 to respective anchors 130, 132. In one embodiment the predetermined distance may be approximately 3 feet to 4.5 feet.

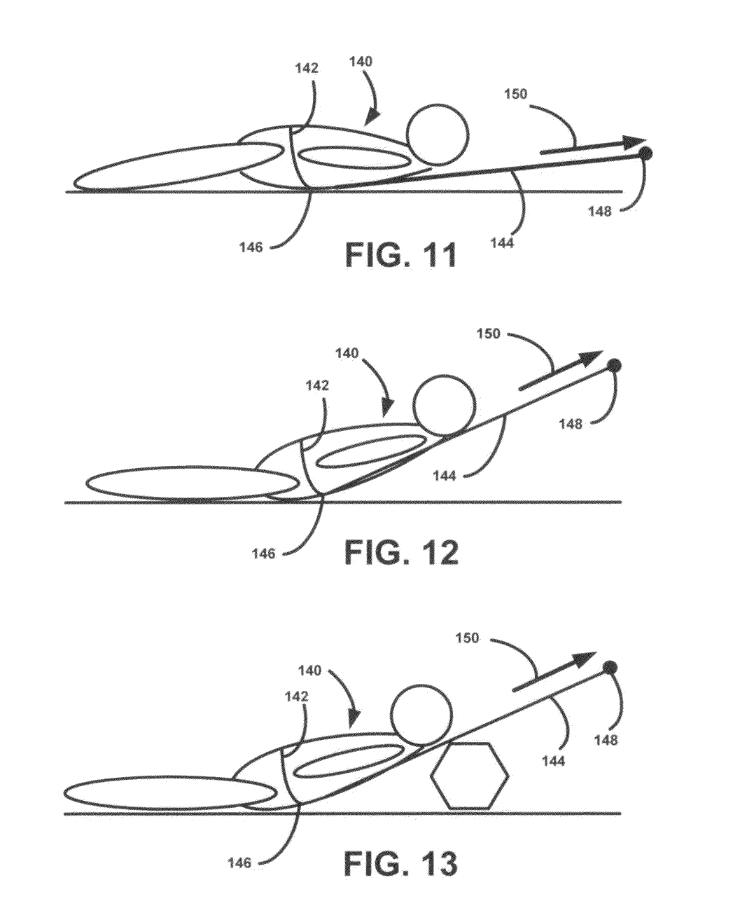

The present embodiments provide a significant advantage over prior art drag methods and apparatus. FIGS. 11, 12 and 13 depict how a casualty, such as an injured police officer or fireman may be safely and efficiently dragged from an area of danger. A first person 140 may be operatively coupled to a duty belt 142 which is operatively coupled to an extendable portion 144 at an anchor 146. The extendable portion 144 has a grasping area 148. When a force 150 as applied to the grasping area 148 the first a person 140 may be dragged by a second person (not shown). In general the second person may grasp the grasping area 148 and as the second person moves away from the first person the extendable portion 144 extends to the extended orientation. When the extendable portion 144 is fully extended the second person is free to drag the first person. The second person may move in an unencumbered manner and, for example, FIG. 11 depicts a situation where the second person may be crawling, FIG. 12 depicts a situation which the second person may be walking or running upright. FIG. 13 depicts the first person being dragged over an obstacle when necessary. The extended portion 144 allows the grasping area 148 to be at a predetermined distance from the first person 140, thereby the second person is substantially unimpeded by the first person while dragging the first person. Thus the second person may drag the first person over substantially level terrain; over obstacles, in a face up position, a facedown position, or a side position. The second person is unimpeded even in dragging the first person when a further injured person is holding onto the first person. In any example where the second person running to drag the first person from a dangerous area, the second person a free to run without danger of having his legs become entangled or impeded by the first person.

In one embodiment where the apparatus may be a suspender like structure that is operatively coupled with anchors to at least one of an inner belt, a duty belt, or both be inner belt and duty belt of a person, the pulling force at the grasping area may result in approximately 60% of the pulling force occurring at the anchors attached to the belt or belts at the rear of the person, and approximately 40% force occurring at the anchors attached to the front of the person at the belt or belts. It is envisioned that other designs embodied in the different principles set forth here may result in different percentages of forces being applied to the location of the anchors at the belt or belts of the person.

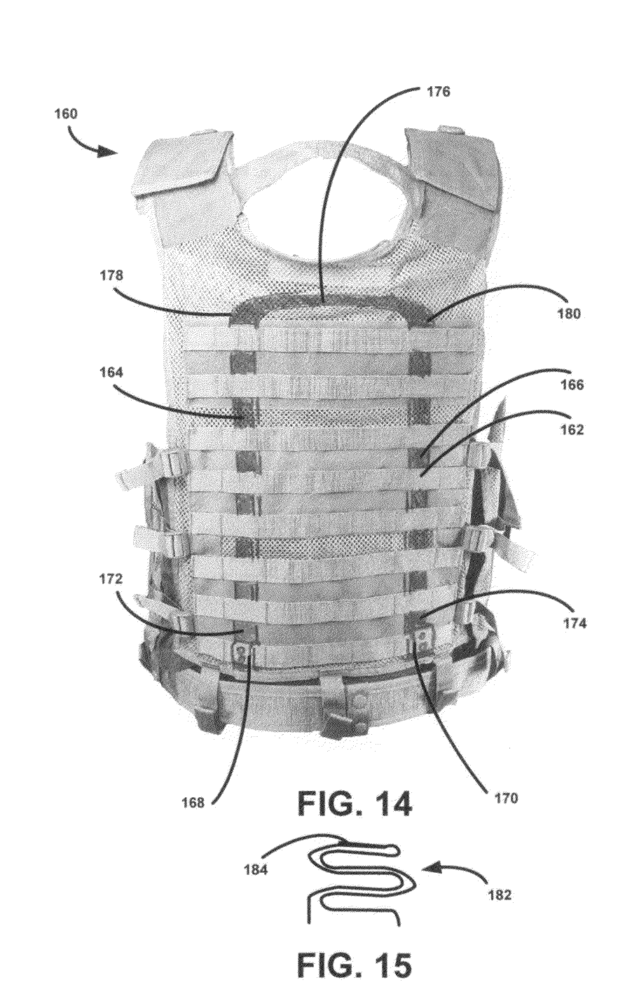

FIG. 14 depicts another embodiment in which the article may be a tactical vest 160 having a plurality of molles 162 on a rear of the vest 160. The extendable portion 164, 166 extends through at least some of the plurality of molles 162. Respective anchors 168, 170 are operatively coupled to predetermined molles of the plurality of molles 162. The extended portion 164, 166 may be stowed in a predetermined molles of the plurality of molles 162 also on the rear of the vest.

For example, in the stowed position the extendable portion may have a pair of extendable sections 164, 166 that are folded into a plurality of molles of the plurality of molles 162 such that the extendable sections 164, 166 are positioned spaced apart on the rear of the vest 160. The first ends 172, 174 of the extendable sections 164, 166 may be attached to anchors 168, 170 that are secured to respective molles that are located near a bottom on the rear of the vest 160. The grasping area 176 attached to second ends 178, 180 of the extendable sections 164, 166 may be located near the shoulder area of a person wearing the vest 160. When the grasping area 176 is pulled away from the vest 160, the extendable sections 164, 166 slip through the molles and result in the extendable sections 164, 166 positioning the grasping area 160 at a predetermined distance from the top of the vest 160.

FIG. 15 depicts an alternative embodiment wherein an extendable portion 182 is folded in a stowed position adjacent to a grasping area 184. The extendable portion 182 extends as a person grabs the grasping area 184 and pulls letting the extendable portion 182 slip from a hand of the person as the grasping area 184 is pulled.

From the description provided above it can be appreciated and that the integrated drag system in the various embodiments provides a lightweight and effective means for removing a person from a dangerous situation. This is particularly useful for injured firemen and injured police officers. In the stowed position the integrated drag system does not interfere with normal operations of firemen and police officers. The following describes embodiments of the integrated drag system in general terms.

In one embodiment of the integrated drag system suspenders of the system may be attached directly to a duty belt in the back using built in belt keepers. The front of the suspenders may be attached to the duty belt by the use of a reducer and supplied belt keepers. Alternatively, the front of the suspenders may be attached directly to the duty belt. In one embodiment the suspender portion of the system may be two continuous pieces of 1.5 inch nylon webbing each attaching at the duty belt in the back, going over the shoulder and securing in the front allowing for the suspenders to adjust to an individual person.

The built in concealed drag strap may be one continuous piece of 0.75 inch nylon webbing attached to both rear suspender straps near an upper back of the person. The shoulder straps of the suspenders may have built in channels to hold and conceal the drag strap. The drag strap may be concealed under an outer vest carrier of common body armor. In one embodiment the suspenders may have two elastic loops, one on each of the straps in an area of the shoulders on the person to allow for adjustment of the height of a grasping area of the integrated drag system.

The integrated drag system deploys simple by taking hold of the exposed loop (grasping area) and pulling the length of nylon webbing (extendable straps) from the storage channels on the vest. An additional component would allow the top loop to be secured to the vest in order to prevent accidental deployment.

In another embodiment of the integrated drag system a drag strap is operatively coupled to a tactical vest that utilizing the Molle system of the tactical vest. The straps may be Z-folded and inserted behind the straps that comprise the Molle system. The integrated drag system does not reduce the available space on the tactical vest as the Molle loops remain accessible. In one embodiment an entire length of webbing that forms the drag strap may be approximately 104 inches and may be contained inside of 2 channels that Velcro (hook and loop tape) close. When completely stowed, the system may be stowed in two stowing compartments and may be joined by the center grasping area of the drag strap. Once inserted behind the Molles the straps may be secured in place using two heavy duty snaps per side.

In one embodiment the material used may be all mil-spec grade nylon webbing and plastic components. The 0.75 inch belt keepers in the rear of the suspenders may be sewn directly into a main body of the suspenders. The belt keepers may be sewn in so that the bottom portion folds up and the snap portion folds over the bottom portion to prevent the integrated belt keeper from becoming snagged while being dragged and thereby coming undone.

In one embodiment the folded portion of the extendable sections may be contained in structures formed from 1.5 inch nylon webbing and may consist of four pieces, 4 inches apart, creating a channel for stowing the drag strap until it is deployed.

The two rear straps of the suspenders may be attached to one another by a bridge section to prevent the straps from slipping off the shoulders of the person during everyday movement and usage. Also the two front straps may be attached to one another by, for example, a removable sternum strap to further prevent the suspenders from falling off the body of the person.

In one embodiment the 0.75 inch nylon drag strap (extendable section) may be fastened to each rear strap creating a loop with attachment points on each suspender strap. Once attached, the 0.75 inch nylon drag strap may be secured in formed webbing channels. The webbing may be fed down the channels with an upper most webbing channel fed last. In another embodiment elastic bands may used to adjust a top of a drag handle (grasping area) to an individual user's needs.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus for substantially attaching to a predetermined article associated with a person, comprising:
a grasping area;
an anchor system for securing to the predetermined article; and
an extendable portion having at least one extendable section having a first stowed position and a second extended position, the at least one extendable section having a first end operatively coupled to the anchor system and a second end operatively coupled to the grasping area.

2. The apparatus according to claim 1,
wherein the anchor system comprises at least a pair of spaced apart anchors releasably secured to spaced apart locations on the predetermined article; and
wherein the extendable portion has at least a pair of extendable sections, each extendable section respectively having a first end operatively coupled to one of a respective anchor or a predetermined location on the article that effects an operative coupling to the respective anchor, and a second end operatively coupled to the grasping area.

3. The apparatus according to claim 1, wherein the anchor is a belt keeper, and wherein the belt keeper is operatively coupled to at least one belt worn by a person, and wherein the belt keeper is oriented such that it caused to remain in a closed position while the person is dragged.

4. The apparatus according to claim 1, wherein each respective anchor is operatively coupled to one of an inner belt, a duty belt, and both an inner belt and a duty belt.

5. The apparatus according to claim 2, wherein
the article is a pair of over the shoulder straps, each of the straps having first and second ends, each of the shoulder straps having front strap portions and rear strap portions, and the anchor system having four anchors;
each of the first ends of the straps operatively coupled to a respective anchor of the four anchors that is operatively coupled to at least one belt of the person, the first ends being spaced apart from one another;
each of the second ends of the straps operatively coupled to a respective anchor of the four anchors that is operatively coupled to the at least one belt, the second ends being spaced apart from one another; and
the first ends of the extendable sections are operatively coupled to predetermined locations on the rear strap portions of the shoulder straps, respectively.

6. The apparatus according to claim 2, wherein the pair of extendable sections and the grasping area are formed from a continuous strap-like structure.

7. The apparatus according to claim 1, wherein the at least one extendable section is temporarily stowed in a containing means structured for restoring the at least one extendable section after it has been extended.

8. The apparatus according to claim 7, wherein the containing means is one of permanently attached to a respective shoulder strap or temporarily attached to the respective shoulder strap.

9. The apparatus according to claim 8, wherein the containing means comprises a plurality of containing sections.

10. The apparatus according to claim 7, wherein each of the extendable sections has a portion that is a Z-fold configuration within the containing means.

11. The apparatus according to claim 1,
wherein the first ends of the extendable portion are operatively coupled to respective anchors relative to a back of the person, and
wherein in the extended configuration of the extendable portion, at least a portion of a pulling force at the grasping area is operatively transmitted via the extension portion to respective anchors thereof.

12. The apparatus according to claim 2, wherein the grasping portion is approximately positioned adjacent a shoulder area on a back of the person when the extendable sections are in respective stowed positions, and wherein the grasping portion is at a predetermined distance from the shoulder area on the back of the person when the extendable sections are in respective extended positions.

13. The apparatus according to claim 12, wherein the predetermined distance is approximately 3.0 feet to 4.5 feet.

14. The apparatus according to claim 7, wherein the apparatus further comprises a further containing means for storing a predetermined portion of the extendable section to thereby effect an adjustable position of the grasping portion relative to a size of the person.

15. The apparatus according to claim 14, wherein the further containing means is located approximately adjacent a shoulder area of the person.

16. The apparatus according to claim 1,
wherein the article is a tactical vest having a plurality of molles on a rear of the vest;
wherein the extendable portion extends through at least some of the plurality of molles on the rear of the vest;
wherein the respective anchors are operatively coupled to predetermined molles on the rear of the vest; and
wherein the extended portion is stowed in a predetermined plurality of molles on the rear of the vest.

17. The apparatus according to claim 1, wherein the apparatus provides for dragging a first person wearing the apparatus by a second person, grasping the grasping area, in at least one of a standing, crouching, and crawling orientation of the second person, and wherein in the extended position of the extendable portion the grasping portion is at a predetermined distance from the first person such that the second person is substantially unimpeded by the first portion while dragging the first person.

18. The apparatus according to claim 17, wherein the apparatus provides for dragging the first person over substantially level terrain, dragging the first person over obstacles, dragging the person in at least one of a face up position, a face down position or a side position, and dragging the person when a further person is holding onto the first person.

19. A person drag system, the person wearing at least one of an inner belt, a duty belt, or both an inner belt and a duty belt, comprising:
suspenders having a pair of over the shoulder straps, each of the straps having first and second ends, each of the shoulder straps having front strap portions and rear strap portions;
an anchor system having a plurality of anchors;
each of the first ends of the straps operatively coupled to a respective anchor of the plurality of anchors that is operatively coupled to the at least one of the inner belt, the duty belt, or both the inner belt and the duty belt, the first ends of the straps being spaced apart from one another;
each of the second ends of the straps operatively coupled to a respective anchor of the four anchors that is operatively coupled to the at least one of the inner belt, the duty belt, or both the inner belt and the duty belt, the second ends of the straps being spaced apart from one another;
an extendable device having two extendable sections, each extendable section having a first stowed position and a second extended position, each extendable section having a first end operatively coupled to predetermined locations on the rear strap portions of the shoulder straps, respectively and a second end operatively coupled to the grasping area;
the extendable sections in the first stowed position temporarily stowed in containing means coupled to the rear strap portions; and
the grasping portion at a predetermined distance from a shoulder area on a back of the person when the extendable sections are in respective extended positions.

20. The apparatus according to claim 19, wherein in the extended configuration of the extendable device approximately 60% of a pulling force at the grasping area is operatively transmitted via the rear strap portions to respective anchors therof, and about 40% of the pulling force at the grasping area is transmitted by the front strap portions to respective anchors therof.
